(19) United States
(12) Patent Application Publication
(10) Pub. No.: US 2024/0067371 A1
(43) Pub. Date: Feb. 29, 2024

(54) MODULAR DRONE CONTAINMENT AND DEPLOYMENT SYSTEM

(71) Applicant: Darkhive, Inc., San Antonio, TX (US)

(72) Inventors: Steven Turner, Nevada City, CA (US); John Goodson, San Antonio, TX (US)

(73) Assignee: Darkhive, Inc., San Antonio, TX (US)

(21) Appl. No.: 18/228,973

(22) Filed: Aug. 1, 2023

Related U.S. Application Data
(60) Provisional application No. 63/400,631, filed on Aug. 24, 2022.

(51) Int. Cl. B64U 80/70; B64U 50/37; B64U 70/50; B64U 80/40

(52) U.S. Cl. CPC B64U 80/70; B64U 50/37; B64U 70/50; B64U 80/40

(57) ABSTRACT

A modular drone containment system including a plurality of modular stacked drone containers. Each modular drone container is configured to house a drone device and be removably disposed in a stacked orientation relative to one another. Each modular container includes a sidewall having a continuous upstanding wall defining a containment space configured to house a respective drone device. A topmost modular container in the stacked orientation further includes a top cover pivotally attached to a top portion of its sidewall. A bottommost modular container in the stacked orientation includes a bottom wall attached to a bottom portion of its sidewall. Further included is a charging system configured to simultaneously charge a battery provided in each drone housed in a stacked modular container.

### CROSS REFERENCE TO RELATED APPLICATIONS

This application claims priority to U.S. Patent Application Ser. No. 63/400,631 filed Aug. 2, 2022 which is incorporated herein by reference in its entirety.

### BACKGROUND

### 1. Field

The disclosed embodiments generally relate to a container for Uncrewed Aerial Vehicles (UAVs), and more particularly, to a modular UAV containment and deployment system.

### 2. Description of Related Art

A drone, i.e., an Uncrewed Aerial Vehicle (UAV), can be used for various operations, such as data gathering and communications. Drones can have limited ranges and it may not be desirable to launch a drone until it is needed and/or in a location where the drone can be useful. Prior art systems include modular drone containment designs for autonomous systems deployment. However, these systems are large, heavy, are difficult to transport and often require bulky mechanical doors. They often may only contain a single drone due to the physical construction of the drones typically carried, which is not conducive for stacking such drone containers atop one another.

Thus, there is a need for a drone containment device and system facilitating the easy and safe transport of drones, and charging, that further allows easy drone launching and recovery.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with the illustrated embodiments, described herein is a drone container system providing an enclosure configured to contain multiple drones (UAVs) for transport, deployment, and recovery. Each container preferably provides a charging system configured and operational to enable multiple UAVs to be inserted or land in a stacked configuration in a compact, rugged, and lightweight container. It is to be appreciated that when the UAVs are disposed in a stacked arrangement in a container, each UAV is enabled to lift off and land independently within the “stack” for deployment and recovery. In certain embodiments, the UAV container is analogous to an ammunition magazine whereby UAVs are packed in a tight configuration for protecting them and ensuring they are ready for deployment from other autonomous platforms, vehicles, or in a standalone configuration on buildings or in austere configurations. Exemplary use scenarios include perimeter security, border monitoring, law-enforcement safety and pursuit, search and rescue, and discrete surveillance from other autonomous platforms.

Certain embodiments disclosed herein provide a ruggedized, modular container that preferably accommodates a plurality of UAVs. Such containers may be stacked atop one another and reside on a modular base for charging. These bases may be exchanged for additional requirements such as power, networking, or computing capabilities. In accordance with the preferred embodiments, the containers also preferably provide electromagnetic interference protection for shielding the enclosed UAVs in a Faraday cage-like grounded construction. A lid is preferably pivotally attached to a top portion of a container, and is preferably spring loaded and retracted by a mechanical actuator.

In operation, once a lid is opened, UAVs enclosed in the container are enabled to deploy (take off) in order from top to bottom, relative to the container, which may be to accomplish a certain objective/mission for the UAVs once in flight. For recovery of UAVs in flight, a portion of the lid and/or charging pad may be provided with indicia (e.g., patterns), and/or a transmitter for sending navigation signals, to aid the UAVs for precision landing within the container. During landing operations, a container lid opens enabling UAVs to land within the container so as to preferably restack themselves within the container they took flight from. The lid then preferably closes whereafter the stacked UAVs begin charging automatically via a charging assembly provided by the container. It is to be appreciated that the containers may be arranged in any orientation, provided there is sufficient room for UAVs to take flight unobstructed, or float to the surface of water.

Another aspect of the illustrated embodiments provides a modular drone containment system including a plurality of modular stacked drone containers. Each modular drone container is configured to house a drone device and be removably disposed in a stacked orientation relative to one another. Each modular container includes a sidewall having a continuous upstanding wall defining a containment space configured to house a respective drone device. A topmost modular container in the stacked orientation further includes a top cover pivotally attached to a top portion of its sidewall. A bottommost modular container in the stacked orientation includes a bottom wall attached to a bottom portion of its sidewall. Further included is a charging system configured to simultaneously charge a battery provided in each drone housed in a stacked modular container.

Yet another aspect of the illustrated embodiments provides modular drone containment system having a plurality of stacked modular drone containers. Each stacked modular drone container is configured to house a drone device and is removably disposed in a stacked orientation relative to one another. At least one modular drone container is coupled to a networking device configured to provide computer network coupling to a computer system. Each modular container includes a sidewall having a continuous upstanding wall defining a containment space configured to house a respective drone device. A topmost modular container in the stacked orientation further includes a top cover pivotally attached to a top portion of its sidewall. A computer controlled mechanical actuator assembly is coupled to the top cover such that the coupled computer system causes the opening and closing of the top cover relative to its containment space. A bottommost modular container in the stacked orientation includes a bottom wall attached to a bottom portion of its sidewall. A charging system is provided configured to simultaneously charge a battery provided in each drone housed in a stacked modular container. Further provided is a Global Positioning Satellite (GPS) device operatively coupled to the computer system wherein the computer system is configured to analyze data from the GPS device to determine GPS coordinates associated with the stacked modular containers and send the determined GPS to one or more drones in flight for facilitating navigational landing of the one or more drones in flight relative to a current position of the stacked modular containers. Additionally provided is a drone proximity sensor communicatively coupled to the computer system to cause actuation of the mechanical actuator assembly to cause the top cover to pivot to an open position responsive to a drone in flight being within a predetermined distance from stacked modular drone containers. In certain embodiments, a modular base portion is operatively associated with the charging system and being configured to support the plurality of stacked modular drone containers, wherein the charging system includes one or more charging pads configured to electrical couple to one or more charging contacts provided on a drone disposed adjacent the bottom wall of the bottommost modular container in the stacked orientation. Each of a plurality stacked drones housed in the containment space in certain embodiments include respective electrical contacts that electrically couple to one another such that a bottommost stacked drone adjacent the charging system causes simultaneous charging of each stacked drone via their respective electrical contacts.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates a system overview of a containment system in accordance with the illustrated embodiments;

FIGS. 2A-2C illustrate an exemplary Uncrewed Aerial Vehicle (UAV) utilized with the containment system in accordance with the illustrated embodiments;

FIGS. 3A-3D illustrate the containment system of FIG. 1;

FIGS. 4A-4D illustrate certain views of the containment system of FIG. 1; and

FIG. 5 illustrates one or more internal and external components of the computing system coupled to the containment system of FIG. 1 in accordance with an illustrative embodiment.

### DETAILED DESCRIPTION OF CERTAIN EMBODIMENTS

Aspects of the disclosed embodiments are shown in the following description and related drawings directed to specific illustrated embodiments. Alternate preferred embodiments may be devised without departing from the scope of the illustrated embodiments. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Where a range of values is provided, it is understood that each intervening value, to the tenth of the unit of the lower limit unless the context clearly dictates otherwise, between the upper and lower limit of that range and any other stated or intervening value in that stated range is encompassed within the illustrated embodiments. The upper and lower limits of these smaller ranges may independently be included in the smaller ranges is also encompassed within the illustrated embodiments, subject to any specifically excluded limit in the stated range. Where the stated range includes one or both of the limits, ranges excluding either both of those included limits are also included in the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It is to be appreciated the illustrated embodiments discussed below preferably utilize a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

In accordance with the below description of certain illustrated embodiments, disclosed herein is a ruggedized, modular container system 200 that preferably accommodates a plurality of UAVs 100. Such containers 10 may be stacked atop one another and reside on a modular base 400 for charging. As described, these bases 400 may be exchanged for additional requirements such as power, networking, or computing capabilities. In accordance with the preferred embodiments, the containers 10 also preferably provide electromagnetic interference protection for shielding the enclosed UAVs 100 in a Faraday cage-like grounded construction. A door/lid 16 is preferably pivotally attached to a top portion 17 of a container 10, and is preferably spring loaded and retracted by a mechanical actuator.

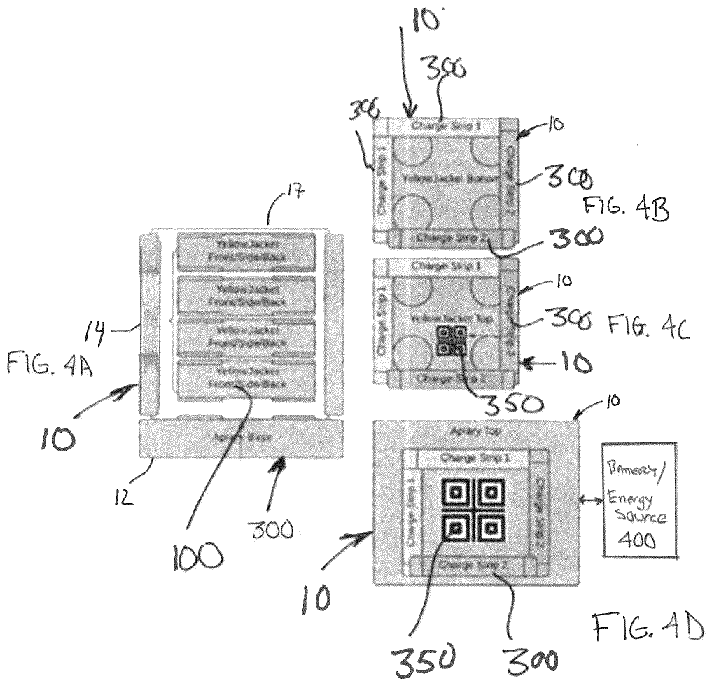

In operation, once a lid 16 is opened, UAVs 100 enclosed in the container 10 are enabled to sequentially take off in order from top to bottom, relative to the container 10, which may be to accomplish a certain objective/mission for the UAVs 100 once in flight. For recovery of UAVs 100 in flight, a portion of the lid 16 and/or charging pad 300 (FIG. 4) may be provided with indicia 350 (e.g., patterns) to aid with vision navigation system(s) provided on the UAVs 100 for enabling precision landing. During landing operations, a container lid 16 opens enabling UAVs 100 to land within the container 10 so as to preferably restack themselves within the container 10 they took flight from. The lid 16 then preferably closes whereafter the stacked UAVs 100 begin charging automatically via a charging assembly 300 provided by the container 10. It is to be appreciated that the containers 100 may be arranged in any orientation, provided there is sufficient room for UAVs 100 to take flight unobstructed, or float to the surface of water.

In accordance with the below illustrated embodiments, it is to be appreciated that a “drone” as used herein means an Uncrewed Aerial Vehicle (UAV) 100. Drones can be either autonomous or non-autonomous. Autonomous drones have operation parameters, e.g., speed, direction, altitude, etc., controlled by a computer. Non-autonomous drones are controlled by a remote human operator. Drones are available with a variety of aeronautic performance capabilities. For example, drones may have a fixed wing configuration requiring either a runway or a launch assist device, e.g., a catapult, to get airborne. Alternatively, drones may have rotors with rotating airfoils, i.e., rotor blades, allowing substantially vertical launches and landings. A helicopter-type drone may include a single rotor or two rotors. Drones may have more than one or two rotors. In accordance with the embodiments illustrated herein, the illustrated example of a drone 100, a quadcopter, has four rotors. It is to be appreciated the illustrated embodiments are not to be understood to be limited to such as quadcopter as other applicable configurations may include a bicopter with two rotors, a tricopter with three rotors, a hexacopter with six rotors, an octocopter with eight rotors, and so on. It is to be further appreciated that aerial drones, particularly when used in combination with land-based motor vehicles, may be used to support the military, public safety agencies, fire departments, search and rescue operations, wildlife research, scientific research, agriculture, meteorology, aerial mapping, pollution monitoring, and the like.

It is to be appreciated that relative orientations and directions (by way of example, upper, lower, bottom, forward, rearward, front, rear, back, outboard, inboard, inward, outward, lateral, left, right) are set forth in this description not as limitations, but for the convenience of the reader in picturing at least one embodiment of the structures described. Such example orientations are from the perspective of an occupant seated in a seat, facing a dashboard. In the Figures, like numerals indicate like parts throughout the several views.

In accordance with the illustrated embodiments described herein, a drone container 10 preferably includes a base 12, a top 17, sidewalls 14, a lid/door 16 and an energy source 300. The top portion 17 has an opening 18 sized to receive a drone 100. The sidewalls connect the base 12 and top 17 portions. The door 16 is disposed in the opening 18 formed in the top portion 17 of a container 10. An actuator is connected to the door 16 for opening and closing the door relative to the opening 18 formed in the top portion 17 of a container 10. For instance, in some illustrated embodiments, a motor is electrically connected to the battery and is drivingly connected to the door 16. A computer 500 is communicatively coupled to the motor and is programmed to selectively open and close the door 16 responsive to an operation of a drone 100. In the context of this disclosure “communicatively coupled” means connected in a wired or wireless manner such as is known to receive data and/or provide commands. Each drone 100 disposed in a container 10 preferably includes a wireless transceiver for communicating data over the wireless transceiver whereby the wireless transceiver may allow communication between a container 10 and the drone 100.

A drone container 10 preferably includes a container shell, a door 16, a battery, a motor and a computer 500. The door motor is electrically connected to the battery and is drivingly connected to the door 16. The computer 500 is preferably programmed to actuate the motor to open and close the door 16 responsive to an operation of the drone 100. The computer 500 may be further programmed to actuate the motor to open the door 16 responsive to a determination that a drone 100 is within a predetermined distance of a container 10. The drone container 10 may further include a selectively actuatable door lock communicatively coupled to the computer 500. The drone container 10 may further include a door-open sensor located at a start of travel position of the door 16 and communicatively coupled to the computer 500. The drone container 10 may further include a door-closed sensor located at an end of travel position of the door 16 and communicatively coupled to the computer 500. The drone container 10 may further include a battery charger electrically connected to the battery (energy source 300).

The drone container 10 may further include a docking station sensor. The computer 500 may be further programmed to detect a presence of the drone 100 within the container 10 based on data from the docking station sensor and to actuate the motor to close the door 16. The drone container 10 may further include a GPS sensor communicatively coupled to the computer 500 whereby the computer 500 is further programmed to use data from the GPS sensor to determine a distance between the drone 100 and the container 10. Additionally, the drone container 10 may further include a drone proximity sensor communicatively coupled to the computer 500 for further aiding the computer to open the lid 16 for reception of an approaching drone 100.

As mentioned above, the container system 200 of certain illustrated embodiments may include providing a battery/energy source 400 for providing inductive battery charging of one or more drones 100 wherein a inductive battery charger assembly (e.g., charging strips 300, FIG. 4) is electrically connected to the battery/source 400. Thus a battery of a drone 100 disposed in a container 10 is charged wirelessly in the container 10 when the drone 100 is within the container 10. A docking station sensor may be provided in a container 10 configured and operable to determine that a drone 100 is within the container 10 wherein it is responsive to detect the presence of a drone 100 within the container 10. In certain embodiments, the determination of the drone 100 being located within a container 10 may contingent upon data from the docking station sensor whereby the computer 500 controls a motor to close the door 16 responsive to the determination that the drone 100 is within the container 10.

In accordance with certain embodiments, the container system 200 includes providing one or more containers 10 with a door-open sensor configured to determine whether the top lid door 16 is open so as to cause a signal to be transmitted to one or more drones 100 in flight for effectuating landing of one or more drones 100 inside the container 10. Thus, the signal communicated to the drone 10 is indicative of the lid door 16 being open and is responsive to a determination that the lid door 16 is open for landing the drone 100 inside the container 10 upon a drone 100 receiving the signal indicative of the lid door 16 being open. Additionally, a drone proximity sensor may be provided in a container 10 that is operable and configured to determine a distance of a drone 100 from the container 10 based on data from the proximity sensor to open the lid door 16 when the drone 100 is within a predetermined distance of the container 10 to facilitate landing of the drone 100.

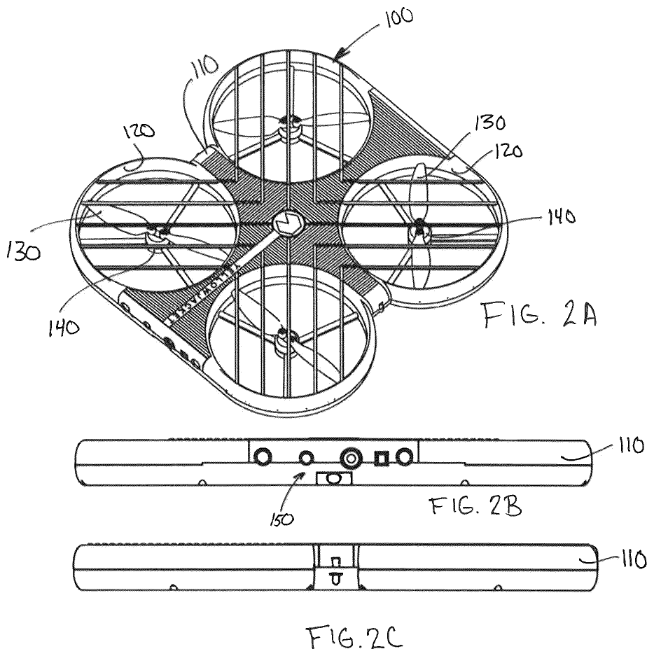

For brevity of description, and with reference to FIG. 2, an illustrative drone 100 that may be used with the containment system 10 of illustrated embodiments (as described below) preferably is driven by four electric motors (not shown), one for each rotor. For instance, it is to be understood and appreciated an exemplary UAV 10 is shown and described in commonly assigned U.S. patent Ser. No. 63/394,391, the contents of which are incorporated herein in their entirety.

The drone 100 carries an on-board battery, i.e., a drone battery, that provides electrical power to the drone 100 and to all on-board electronics. Preferably, the drone 100 is lightweight (e.g., sub-250 gram) UAV 100 having enclosed rotors, particularly adapted for public safety and defense applications. The UAV 100 of the illustrated embodiments is configured for reduced cost and thus is disposable in the event of a crash due to its reduced cost. It is preferably configured for rapid deployment (e.g., via throwing by a user) and for providing autonomous flight. Additionally, the UAV 100 of the illustrated embodiments is configured to have a small footprint, while also being operable for an aforesaid single-handed launch/throw. The UAV 100 preferably has a fully enclosed ergonomic frame configured to be durable and which prevents user contact with its rotors via a configuration and construction that does not negatively impact its autonomous flight characteristics. The UAV 100 preferably includes software configured and operable to enable it to operate with direct pilot interaction, and also autonomously without radio operation with a pilot. Preferably, the UAV 100 is configured to be operable via a single hand-throw from a user enabling rapid deployment, recovery and autonomous stabilization of the UAV 100, which is accomplished via its unique design characteristics, as described below.

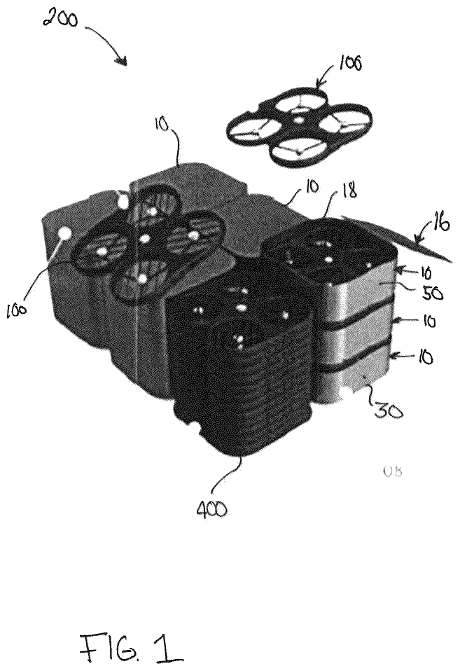

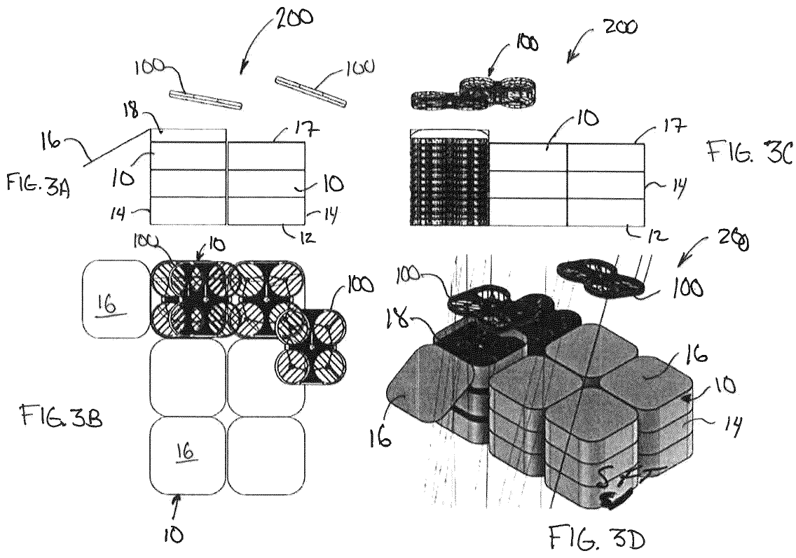

It is to be further appreciated and understood the UAV 100 is preferably designed to be stacked upon other UAVs 100, as shown in FIGS. 1 and 3. Additionally, in accordance with certain illustrated embodiments, each UAV 100 may preferably be waterproof and buoyant. In accordance with the illustrated embodiments, each UAV 100 preferably includes: an electronics controller configured for providing autonomous flight; a microcontroller for motor control purposes; a GPS receiver for position data; and multiple camera sensors for providing visual data to a UAV 100 operator as well as providing aid for GPS-denied navigation. Components of the UAV 100 are preferably designed to minimize internal interference.

As also further described below, charging of the UAV 100 is preferably accomplished via a charge port provided in its frame (e.g., a USB-C port) or via removable battery cells. It is to be appreciated that in accordance with certain illustrated embodiments, the UAV 100 may be configured such that charging is provided when multiple units are stacked atop of each other whereby the stacked UAVs 100 are simultaneously charged (as shown in FIGS. 1 and 3). In accordance with certain illustrated embodiments, the body 110 includes electrical contacts connected to a battery designed to electrically connect with electrical contacts positioned on external devices for enabling the UAV 100 to charge when disposed in a containment device 10 and/or stacked atop other UAVs.

Additionally, the UAV 100 preferably is compatible with current commercially available user communication devices (e.g., smart phones having either an iOS or Android operating system) preferably having a machine learning acceleration processor, microphones, and network connection to external autonomous systems. A software module is implemented on the aforesaid user communication device specifically configured to enable the user communication device to capture audio (e.g., voice), authenticate the audio (e.g., voice), and interpret speech into high-level commands for enabling operation of the UAV 100, whereby observations determined by the user communication device, via the implemented software module, are preferably relayed to a user of the communication device through internal speakers, external headset(s) and/or other external radio systems. The UAV 100 preferably includes software configured and operable to enable operation of the UAV 100 when requiring radio contact to an operator via a user communication device, or alternatively, autonomous operation of the UAV 100 not requiring radio connection to an operator.

In accordance with the illustrated embodiments, each UAV 100 is preferably controlled by current commercially available user communication devices (e.g., smart phones) preferably having a machine learning acceleration processor, microphones, and network connection to external autonomous systems. Preferably a software module is implemented in the user communication device enabling the user communication device to capture audio (e.g., voice), authenticate the audio (e.g., voice), and interpret speech into high-level commands for enabling control of a communicatively coupled UAV 100.

Thus, with reference to FIG. 2, the exemplary drone 100 may be used with the containment system 10 of illustrated embodiments (as described below) which preferably includes a generally planar body 110 enclosing a battery energy source (not shown). A plurality of duct openings 120 may be provided in the planar body 110 wherein a rotor 130 assembly is respectively rotatably mounted in each duct opening 120 for propulsion of the UAV 100. An electric motor assembly 140 is respectively coupled to each rotor assembly 130, whereby each electric motor assembly 140 is electrically coupled to the battery source. A camera assembly 150 is also provided in the body portion 110, as is a wireless communication interface (no shown) for controlling the UAV 100 and transmitting images from the camera assembly 150 to a mobile user communication device. An electronic controller is preferably coupled to the battery source configured to provide autonomous flight for the UAV 100, as described herein. As mentioned above, the drone device 100 shown in FIG. 2 is provided for illustrative purposes only of an exemplary UAV 100 used in accordance with the illustrated embodiments of FIGS. 1 and 3, as the UAV 100 of the illustrated embodiments is not to be understood to be limited to the UAV 100 shown in FIG. 2.

Turning now to FIGS. 1-3, depicted are various views of an exemplary modular drone containment and deployment system, designated generally by reference numeral 200. System 200 preferably includes a plurality of containers 10 each forming a container shell for enclosing a plurality of drones 100 (e.g., five) in a stacked orientation. The example container 10 may be in the shape of a square/rectangular box with a bottom side or base that is substantially rectangular in shape as illustrated in FIG. 3. The illustrated container provides a bottom wall 12, and a sidewall 14 having four sides, and preferably a pivoting top wall/lid 16. The side wall 14 is disposed between and connects the bottom 12 and a top lid 16. The top lid 16 provides an opening 18 to container 10 that is selectively opened and closed, as discussed further below. The opening 18 is sized to receive a drone 100.

In accordance with the illustrated embodiments, each container 10 preferably includes a bottom wall 12, a continuous sidewall 14 having a first end upstanding from the bottom wall 12 defining a containment space 18 configured to house the plurality of drones 100 in the stacked orientation. Each container 10 preferably includes a top cover 16 pivotally attached to a portion of the sidewall 14 opposite the bottom wall 12. It is to be appreciated and understood, the bottom wall 12 and top cover 16 of each modular container 10 is detachable such that a bottom most stacked container 30 has its top cover detachably removed while a top most stacked container 40 has its bottom wall detachably removed, any modular containers 50 disposed intermediate the top 40 and bottom 30 stacked modular containers 10 has both their respective top cover 16 and bottom wall 12 detachably removed.

In accordance with the illustrated embodiments, each modular container 10 preferably includes the top cover 16 being spring loaded for facilitating opening and closing of the top cover 16 relative to its containment space 18. Preferably, in some embodiments, a mechanical actuator assembly is provided in each modular container 10 facilitating opening and closing of the top cover 16 relative to its containment space 18, as mentioned and described above via coupling to computer system 500.

As best shown in FIG. 4, each container 10 also preferably includes a charging system 300 configured to simultaneously charge a battery provided in each stacked drone 100 housed in the containment space 18 of a container 10, wherein the charging system 300 is coupled to an energy source. The energy source may be any suitable energy source, such as a rechargeable energy source provided internal of each modular container 10 or a rechargeable energy source provided external of each modular container 10. In accordance with the illustrated embodiments, and as best shown in FIG. 4, the charging system 300 preferably includes one or more electrical charging contacts 310 configured to electrically couple to charging contacts provided on each of the plurality of drones 100 stacked in the containment space. The charging system 300 is additionally configured and operational to simultaneously charge the plurality of drones 100 stacked in the containment space 18 of each modular container 10.

As best shown in FIG. 1, the containment and deployment system 200 may further include a modular base portion 400 configured to contain and support a plurality of stacked containers 10. The modular base portion 400 may preferably provide an energy source for providing electrical energy (as previously described) to each of the stacked containers 10 disposed atop the modular base portion 400. Additionally, a modular base portion 400 may further include a networking device configured to provide computer network coupling between an external computing component and each of the plurality of drones 100 stacked in the at least one modular container 10. Also, each modular container 10 preferably has a construction providing electromagnetic interference protection that shields drones 100 stacked therein in a faraday cage grounded construction.

In accordance with the illustrated embodiments, it is to be appreciated and understood that each modular container 10 is preferably configured and operational to provide successive flight deployment of each stacked drone 100 therein. Likewise, it is to be appreciated and understood that each modular container 10 is preferably configured and operational to provide successive flight recovery of each stacked drone 100 therein.

With reference now to FIG. 4, to facilitate such landing of the drones 100 in a container 10, a portion of the top cover 16 of a container 10 is preferably provided with a distinctive image 350 for aiding flight recovery of one or more drones 100 into the containment space 18. Additionally, a portion of the bottom wall 12 may likewise be provided with a distinctive image 370 for aiding flight recovery of one or more drones 100 into the containment space 18. Further, it is to be appreciated and understood, a container 10 may be configured and operational to transmit a wireless network signal for flight recovery of one or more drones 100 into the containment space 18, preferably via communicatively coupled computer system 500.

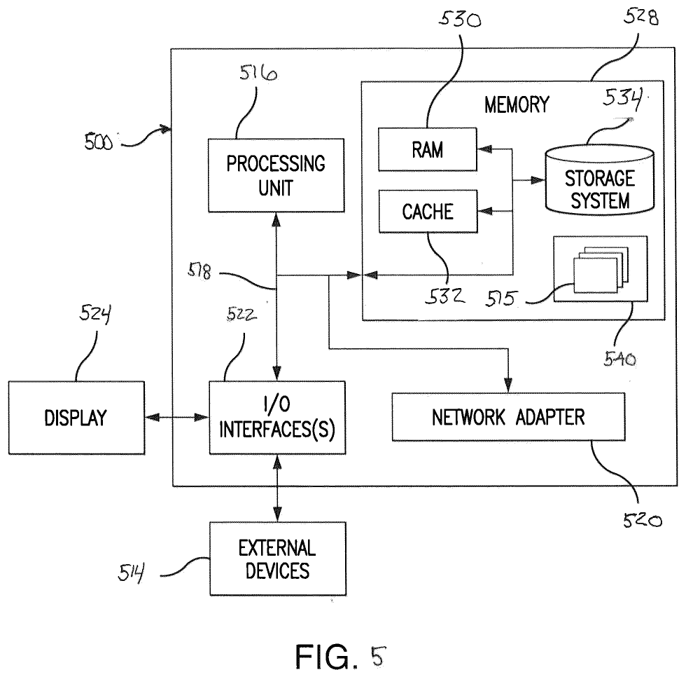

With the illustrated embodiments of FIGS. 1-4 described above, FIG. 5 illustrates one or more internal and external computer components coupled to one or more components of the above-described containment system 200, in accordance with the above-described illustrated embodiments.

In particular, computer system 500 may be described in the general context of computer system-executable instructions, such as program modules, being executed by a computer system. Generally, program modules may include routines, programs, objects, components, logic, data structures, and so on that perform particular tasks or implement particular abstract data types. The containment system 200 coupled to computer system, 500 may be operated in networked coupled data processing environments where tasks are performed by remote processing devices that are linked through a communications network.

The computer system 500 is generally shown in FIG. 5 in the form of general-purpose computing devices. The components of computer system 500 may include, but are not limited to, one or more processors or processing units 516, a system memory 528, and a bus 518 that couples various system components including the system memory 528 to the processor 516.

The bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system 500 typically may include a variety of computer system readable media. Such media may be any available media that is accessible by the computer system 500, and it may include both volatile and non-volatile media, removable and non-removable media.

The system memory 528 can include computer system readable media in the form of volatile memory, such as random access memory (RAM) 530 and/or cache memory 532. The UAV 100 may further include other removable/non-removable, volatile/non-volatile computer system storage media. By way of example only, a storage system 534 can be provided for reading from and writing to a non-removable, non-volatile memory. As will be further depicted and described below, the memory 528 may include at least one program product having a set (e.g., at least one) of program modules that are configured to carry out the functions of embodiments of the illustrated embodiments.

A program/utility 540, having a set (at least one) of program modules 565 that perform the disclosed methods may be stored in the memory 528 by way of example, and not limitation, as well as an operating system, one or more application programs, other program modules, and program data. Each of the operating system, one or more application programs, other program modules, and program data or some combination thereof, may include an implementation of a networking environment. Program modules 515 generally carry out the functions and/or methodologies of embodiments of the invention as described herein.

The containment system 200, via computer system 500, may also communicate with one or more external devices 514 such as a keyboard, a pointing device, a display 524, etc.; one or more devices that enable containment system 200, via computer system 500 (e.g., network card, modem, etc.) to communicate with one or more other computing devices. Such communication can occur via Input/Output (I/O) interfaces 522. Still yet, the containment system 200, via computer system 500 can communicate with one or more networks such as a local area network (LAN), a general wide area network (WAN), and/or a public network (e.g., the Internet) via a network adapter 520. As depicted, the network adapter 520 communicates with the other components of the containment system 200. It should be understood that although not shown, other hardware and/or software components could be used in conjunction with the computer system 500. Examples, include, but are not limited to: microcode, device drivers, software-defined radios, redundant processing units, external disk drive arrays, tape drives, and data archival storage systems, etc.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A modular drone containment system, comprising:
a plurality of stacked modular drone containers each configured to house a drone device and be removably disposed in a stacked orientation relative to one another, wherein each modular container includes:
a sidewall having a continuous upstanding wall defining a containment space configured to house a respective drone device wherein a topmost modular container in the stacked orientation further includes a top cover pivotally attached to a top portion of its sidewall, and wherein a bottommost modular container in the stacked orientation includes a bottom wall attached to a bottom portion of its sidewall; and
a charging system configured to simultaneously charge a battery provided in each drone housed in a stacked modular container.

2. The modular drone containment system as recited in claim 1, wherein each modular drone container has a construction providing electromagnetic interference protection for a drone housed with the modular drone container.

3. The modular drone containment system as recited in claim 1, further including a modular base portion operatively associated with the charging system and configured to support the plurality of stacked modular drone containers.

4. The modular drone containment system as recited in claim 3, wherein the charging system includes one or more charging pads configured to electrical couple to one or more charging contacts provided on a drone disposed adjacent the bottom wall of the bottommost modular container in the stacked orientation.

5. The modular drone containment system as recited in claim 4, wherein each of a plurality stacked drones housed in the containment space includes respective electrical contacts that electrically couple to one another such that a bottommost stacked drone adjacent the charging system causes simultaneous charging of each stacked drone via their respective electrical contacts.

6. The modular drone containment system as recited in claim 4, wherein the charging system includes an inductive charging assembly configured to inductively charge a plurality of drones disposed in the plurality of stacked modular containers.

7. The modular drone containment system as recited in claim 1, wherein the top cover is spring loaded for facilitating opening and closing of the top cover relative to its containment space.

8. The modular drone containment system as recited in claim 1, wherein at least one modular drone container is coupled to a networking device configured to provide computer network coupling to a computing system.

9. The modular drone containment system as recited in claim 8, further including a computer controlled mechanical actuator assembly coupled to the top cover such that the coupled computer system causes the opening and closing of the top cover relative to its containment space.

10. The modular drone containment system as recited in claim 9, further including a Global Positioning Satellite (GPS) device operatively coupled to the computing system wherein the computing system is configured to analyze data from the GPS device to determine GPS coordinates associated with the stacked modular containers and send the determined GPS to one or more drones in flight for facilitating navigational landing of the one or more drones in flight relative to a current position of the stacked modular containers.

11. The modular drone containment system as recited in claim 9, further including a drone proximity sensor communicatively coupled to the computer system to cause actuation of the mechanical actuator assembly to cause the top cover to pivot to an open position responsive to a drone in flight being within a predetermined distance from stacked modular drone containers.

12. The modular drone containment system as recited in claim 9, wherein a portion of the top cover is provided with a distinctive image for aiding flight recovery of one or more drones into the containment space.

13. The modular drone containment system as recited in claim 9, wherein a portion of the bottom wall is provided with a distinctive image for aiding flight recovery of one or more drones into the containment space.

14. The modular drone containment system as recited in claim 9, wherein the computer system is operative to transmit a wireless network signal to one or more drones in flight for facilitating navigational landing of the one or more drones in flight relative to a current position of the stacked modular containers.

15. A modular drone containment system, comprising:
a plurality of modular drone containers each configured to house a drone device and be removably disposed in a stacked orientation relative to one another wherein at least one modular drone container is coupled to a networking computer device configured to provide computer network coupling to a computer system, wherein each modular container includes:
a sidewall having a continuous upstanding wall defining a containment space configured to house a respective drone device wherein a topmost modular container in the stacked orientation further includes a top cover pivotally attached to a top portion of its sidewall, and wherein a bottommost modular container in the stacked orientation includes a bottom wall attached to a bottom portion of its sidewall;
a charging system configured to simultaneously charge a battery provided in each drone housed in a stacked modular container; and
a computer controlled mechanical actuator assembly coupled to the top cover such that the coupled computer system causes the opening and closing of the top cover relative to its containment space.

16. The modular drone containment system as recited in claim 15, further including a Global Positioning Satellite (GPS) device operatively coupled to the computer system wherein the computer system is configured to analyze data from the GPS device to determine GPS coordinates associated with the stacked modular containers and send the determined GPS to one or more drones in flight for facilitating navigational landing of the one or more drones in flight relative to a current position of the stacked modular containers.

17. The modular drone containment system as recited in claim 16, further including a drone proximity sensor communicatively coupled to the computer system to cause actuation of the mechanical actuator assembly to cause the top cover to pivot to an open position responsive to a drone in flight being within a predetermined distance from stacked modular drone containers.

18. The modular drone containment system as recited in claim 15, further including a modular base portion operatively associated with the charging system and configured to support the plurality of stacked modular drone containers.

19. The modular drone containment system as recited in claim 15, wherein the charging system includes one or more charging pads configured to electrical couple to one or more charging contacts provided on a drone disposed adjacent the bottom wall of the bottommost modular container in the stacked orientation.

20. The modular drone containment system as recited in claim 19, wherein each of a plurality stacked drones housed in the containment space includes respective electrical contacts that electrically couple to one another such that a bottommost stacked drone adjacent the charging system causes simultaneous charging of each stacked drone via their respective electrical contacts.
